(19) United States
(12) Patent Application Publication
(10) Pub. No.: US 2008/0132262 A1
(43) Pub. Date: Jun. 5, 2008

(54) Base station cooperation method in communication system and system for the same

(75) Inventors: Young-Ho Jung, Suwon-si (KR); Young-Jae Choi, Bucheon-si (KR); Sang-Min Lee, Suwon-si (KR); Yong Hoon Lee, Yuseong-gu (KR); Jingon Joung, Seoul (KR); Woohyuk Chang, Gyeongsan-si (KR)

Correspondence Address: DOCKET CLERK, P.O. DRAWER 800889, DALLAS, TX, 75380, US

(73) Assignees: Samsung Electronics Co., Ltd., Suwon-si (KR); Korea Advanced Institute of Science and Technology (KAIST), Yusong-gu (KR)

(21) Appl. No.: 11/977,840

(22) Filed: Oct. 26, 2007

(30) Foreign Application Priority Data
Oct. 26, 2006 (KR) 2006-0104481

(51) Int. Cl. H04B 17/00; H04Q 7/20

(52) U.S. Cl. 455/513; 455/509

(57) ABSTRACT

A method of providing a mobile station with communication services through base station cooperation in a communication system. The method includes the steps of: receiving signals from two or more base stations; measuring a strength of each of the received signals; estimating an expected transfer rate of the mobile station; if the estimated expected transfer rate is below a predetermined reference value, selecting at least two bases stations in order of the strength of the received signal; feeding back information on the selected base stations and channel conditions thereof to a serving base station that is providing the mobile station with the communication services or to a base station that is to serve the mobile station; allocating power and resources to the mobile station by the selected base stations; and performing signal transmission/reception with the selected base stations by using the allocated power and resources.

### CROSS-REFERENCE TO RELATED APPLICATION(S) AND CLAIM OF PRIORITY

The present application claims priority to an application filed in the Korean Industrial Property Office on Oct. 26, 2006 and assigned Serial No. 2006-0104481, the contents of which are hereby incorporated by reference.

### TECHNICAL FIELD OF THE INVENTION

The present invention relates to a communication system, and more particularly to a base station cooperation method for enhancing the performance of a mobile station, and a system for the same.

### BACKGROUND OF THE INVENTION

Research has been actively conducted to provide methods for enhancing the performance of a mobile station located at a cell edge in a communication system. One of these methods is a base station cooperation method. When the base station cooperation method is applied, a mobile station with poor channel conditions can improve signal sensitivity as well as transmission power gain by communicating with a plurality of base stations.

FIG. 1 illustrates mobile stations which are provided with communication services through a general base station cooperation method.

Referring to FIG. 1, a mobile station 150 communicates with three base stations 110, 120, and 140, and a mobile station 160 communicates with two base stations 130 and 140. When the mobile stations 150, 160 communicate with the plurality of base stations in this way, the number of base station transmit (Tx) antennas increases as compared to when they communicate with one base station, which results in an increase in diversity gain. Moreover, when any base station uses multiple antennas together with other spatially separated base stations, a correlation between the respective antennas of the multiple antenna decreases as compared to when only one base station uses multiple antennas, and thus diversity gain further increases.

However, there is a problem in that in order to obtain diversity gain through a base station cooperation method, base stations must know instantaneous channel information of all mobile stations using the base station cooperation method.

Further, in base station cooperation methods proposed so far, there is no concrete way to select a mobile station that will use a corresponding base station cooperation method. Thereupon, no concrete way for a base station to allocate resources to a mobile station using a base station cooperation method has been proposed yet.

### SUMMARY OF THE INVENTION

To address the above-discussed deficiencies of the prior art, it is a primary object of the present invention to solve at least the above-mentioned problems occurring in the prior art, and the present invention provides a base station cooperation system and method in a communication system, which is based on an expected transfer rate.

Further, the present invention provides a system and method for selecting a mobile station that can be provided with communication services through base station cooperation in a communication system.

Further, the present invention provides a system and method for allocating resources to a mobile station that is provided with communication services through base station cooperation in a communication system.

In accordance with an aspect of the present invention, there is provided a method of providing a mobile station with communication services through base station cooperation in a communication system, the method including the steps of: receiving signals from two or more base stations; measuring a strength of each of the signals received from the base stations; estimating an expected transfer rate of the mobile station; if the estimated expected transfer rate is below a predetermined reference value, selecting at least two of the bases stations in order of the strength of the received signal; feeding back information on the selected base stations and channel conditions thereof to a serving base station that is providing the mobile station with the communication services or to a base station that is to serve the mobile station; allocating power and resources to the mobile station by the selected base stations; and performing signal transmission/reception with the selected base stations by using the allocated power and resources.

In accordance with another aspect of the present invention, there is provided a method of providing a mobile station with communication systems by a base station in a communication system, the method including the steps of: allocating a same number of sub-channels and same power to each of target mobile stations for base station cooperation; calculating an expected transfer rate of each of the mobile stations, and determining a minimum expected transfer rate; reallocating power in such a manner as to satisfy the minimum expected transfer rate; and if a sum of reallocated power exceeds a total sum of power, and the minimum expected transfer rate is below a predetermined expected transfer rate, reallocating a sub-channel of a mobile station with highest gain per unit sub-channel to a mobile station with lowest gain per unit sub-channel.

In accordance with yet another aspect of the present invention, there is provided a communication system including: a mobile station for receiving signals from two or more base stations, measuring a strength of each of the signals received from the base stations; estimating an expected transfer rate thereof, selecting at least two of the bases stations in order of the strength of the received signal if the estimated expected transfer rate is below a predetermined reference value, feeding back information on the selected base stations and channel conditions thereof to a serving base station that is providing the mobile station with communication services or to a base station that is to serve the mobile station, being allocated power and resources by the selected base stations, and performing signal transmission and reception with the selected base stations by using the allocated power and resources; and the two or more base stations.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a view illustrating mobile stations which are provided with communication services through a general base station cooperation method;

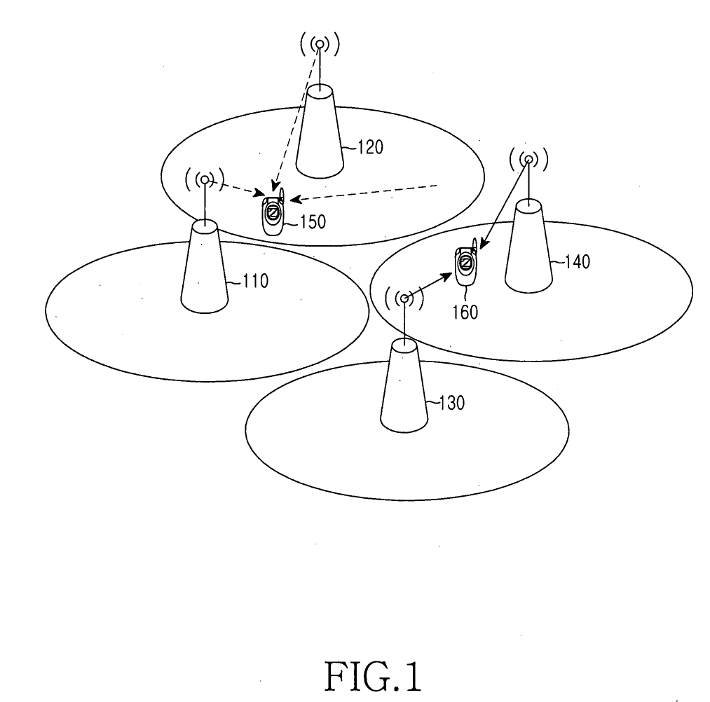

FIG. 2 is a flowchart illustrating a procedure in which a base station allocates power and resources in accordance with an exemplary embodiment of the present invention; and

FIG. 3 is a flowchart illustrating a procedure of providing a mobile station with communication services in accordance with an exemplary embodiment of the present invention.

### DETAILED DESCRIPTION OF THE INVENTION

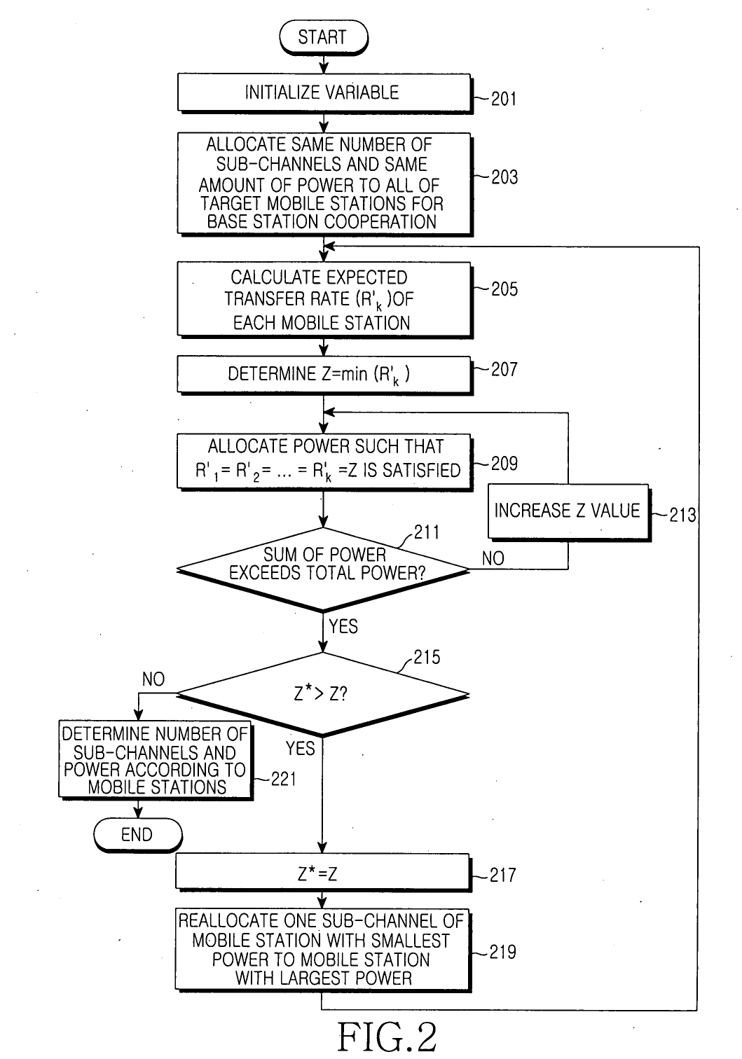

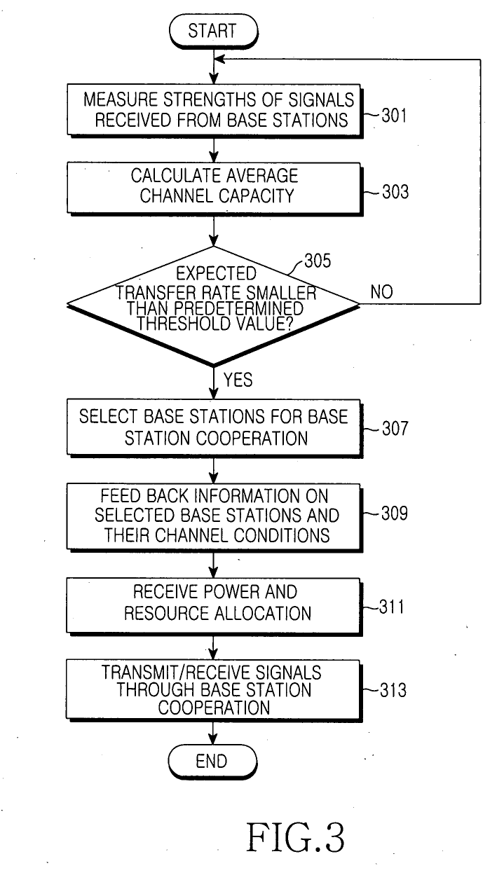

FIGS. 2 through 3, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless network.

The present invention proposes a base station cooperation system and method for selecting a mobile station that can be improved in communication performance through base station cooperation, and allocating resources to the selected mobile station in a communication system.

The base station cooperation system and method according to the present invention may be applied to all kinds of communication systems in which data is transmitted between at least two base stations through the same physical resources.

Reference will now be made to one way to calculate an expected transfer rate used in the present invention, that is, a method of deriving an average channel capacity by using average channel gain, a way to select a mobile station that can be provided with communication services through base station cooperation, and a way to allocate power and resources to the selected mobile station in that order. The expected transfer rate can be expressed as a function of transmission power and average channel gain.

### (1) Derivation of Average Channel Capacity by Using Average Channel Gain

When two base stations transmit transmission symbols by using the Alamouti code, a signal transmitted to one mobile station can be expressed by the following equation:

$${y}_{k} = [ \begin{matrix}{h}_{k , 1} & {h}_{k , 2} \\ - {h}_{k , 2}^{*} & {h}_{k , 1}^{*}\end{matrix} ] {x}_{k} + N \qquad ( Eqn . 1 )$$

In Equation (1), xₖ denotes data to be transmitted to a kth mobile station, and h_{k,1} and h_{k,2} denote complex Gaussian channels from base stations 1 and 2 to the kth mobile station, respectively. Since a distance between the kth mobile station and base station 1 is different from a distance between the kth mobile station and base station 2, the relation between h_{k,1} and h_{k,2} can be represented by h̅_{k,1}≠ h̅_{k,2} (E[h_{k,1}]= h̅_{k,1}, E[h_{k,2}]= h̅_{k,2}). N denotes additive white Gaussian noise.

The signal yₖ is detected in a mobile station, and the detected signal ŷₖ can be expressed by the following equation:

$${\hat{y}}_{k} = [ \begin{matrix}{\vert {h}_{k , 1} \vert}^{2} + {\vert {h}_{k , 2} \vert}^{2} & 0 \\ 0 & {\vert {h}_{k , 1} \vert}^{2} + {\vert {h}_{k , 2} \vert}^{2}\end{matrix} ] {x}_{k} + \hat{N} \qquad ( Eqn . 2 )$$

Here, if a reception signal level γ_{k,j} of γ_{k,j}≅|h_{k,j}|² (j=1, 2) is defined, it can be represented by γ_{k,j}=γ_{k,1}+γ_{k,2}, and a probability density function (PDF) for yₖ can be expressed by the following equation:

$${f}_{{γ}_{k}} ( {γ}_{k} ) = \frac{1}{{\overline{γ}}_{k , 1} - {\overline{γ}}_{k , 2}} [ {e}^{- \frac{{γ}_{k}}{{\overline{γ}}_{k , 1}}} - {e}^{- \frac{{γ}_{k}}{{\overline{γ}}_{k , 2}}} ] \qquad ( 3 )$$

In addition, average Ergodic capacity can be determined by the following equation:

$${R}_{k} = {\int }_{0}^{∞} {log}_{2} ( 1 + \frac{{P}_{k} {γ}_{k}}{N + {I}_{k}} ) {f}_{{γ}_{k}} ( {γ}_{k} ) d {γ}_{k} \qquad ( 4 )$$

In Equation (4), Pₖ denotes transmission power of a kth user, and Iₖ denotes interference. The interference Iₖ may be assumed as Gaussian noise, and the total sum of noise and interference can be represented by the Gaussian noise N′ₖ=N+Iₖ. Also, if it is assumed that the magnitude of noise and interference is the same for all mobile stations, reception SINR (Signal to Interference and Noise Ratio) of the kth mobile station is

$$\frac{{P}_{k} {γ}_{k}}{{N}^{′}} .$$

Thus, average channel capacity can be derived by substituting the PDF of Equation (3) into Equation (4), as given in the following equation:

$$\begin{matrix}{R}_{k} = {\int }_{0}^{∞} {log}_{2} ( 1 + \frac{{P}_{k} {γ}_{k}}{{N}^{′}} ) \frac{1}{{\overline{γ}}_{k , 1} - {\overline{γ}}_{k , 2}} [ {e}^{\frac{{γ}_{k}}{{\overline{γ}}_{k , 1}}} - {e}^{\frac{{γ}_{k}}{{\overline{γ}}_{k , 2}}} ] d γ \\ = \frac{1}{{\overline{γ}}_{k , 1} - {\overline{γ}}_{k , 2}} [ \begin{matrix}{\int }_{0}^{∞} {log}_{2} ( 1 + \frac{{P}_{k} {γ}_{k}}{{N}^{′}} ) {e}^{\frac{{γ}_{k}}{{\overline{γ}}_{k , 1}}} d {γ}_{k} - \\ {\int }_{0}^{∞} {log}_{2} ( 1 + \frac{{P}_{k} {γ}_{k}}{{N}^{′}} ) {e}^{\frac{{γ}_{k}}{{\overline{γ}}_{k , 2}}} d {γ}_{k}\end{matrix} ]\end{matrix} \qquad [ Eqn . 5 ]$$

Meanwhile, a gamma function and an integral function are defined as given in the following equation:

$$\begin{matrix}{I}_{1} ( μ ) = {\int }_{0}^{∞} ln ( 1 + γ ) {e}^{- μ γ} d γ \\ = {e}^{μ} \frac{Γ ( 0 , μ )}{μ} \\ = {e}^{μ} \frac{{E}_{1} ( μ )}{μ}\end{matrix} \\ Γ ( α , x ) = {\int }_{x}^{∞} {t}^{α - 1} {e}^{- t} d t \qquad [ Eqn . 6 ]$$

Using Equation (6), the average channel capacity can be determined by the following equation:

$${R}_{k} = \frac{{N}^{′}}{{P}_{k , 1} {\overline{γ}}_{k , 1} - {P}_{k , 2} {\overline{γ}}_{k , 2}} {log}_{2} e [ {I}_{1} ( \frac{{N}^{′}}{{P}_{k , 1} {\overline{γ}}_{k , 1}} ) - {I}_{1} ( \frac{{N}^{′}}{{P}_{k , 2} \overline{{γ}_{k , 2}}} ) ] = \frac{1}{{P}_{k , 1} {\overline{γ}}_{k , 1} - {P}_{k , 2} {\overline{γ}}_{k , 2}} {log}_{2} e [ {P}_{k , 1} {\overline{γ}}_{k , 1} {e}^{\frac{{N}^{′}}{{P}_{k , 1} {\overline{γ}}_{k , 1}}} {E}_{1} ( \frac{{N}^{′}}{{P}_{k , 1} {\overline{γ}}_{k , 1}} ) - {P}_{k , 2} {\overline{γ}}_{k , 2} {e}^{\frac{{N}^{′}}{{P}_{k , 2} {\overline{γ}}_{k , 2}}} {E}_{1} ( \frac{{N}^{′}}{{P}_{k , 2} {\overline{γ}}_{k , 2}} ) ] \qquad [ Eqn . 7 ]$$

In Equation (7), E₁ is an integral exponential function of

$${\int }^{∞} \frac{{e}^{- xt}}{t} d t .$$

Using the average channel capacity derivation formula of Equation (7), a mobile station can calculate the average channel capacity between the mobile station and a base station which is currently in communication with the mobile station. This average channel capacity between the mobile station and the base station is determined by the following equation:

$${R}_{i} = E [ log ( 1 + \frac{{P}_{i} {γ}_{i}}{N} ) ] = {e}^{\frac{{N}^{′}}{{P}_{i} {\overline{γ}}_{i}}} {log}_{2} {E}_{1} ( \frac{{N}^{′}}{{P}_{i} {\overline{γ}}_{i}} ) \qquad [ Eqn . 8 ]$$

In Equation (8), Pᵢ and γ̅ᵢ denote power allocated by the base station and average channel gain between the base station and the mobile station, respectively, “i” denotes mobile station i, and

$${E}_{1} ( x ) = {\int }^{∞} \frac{{e}_{/}^{- xt}}{t} d t$$

denotes an integral exponential function.

### (2) Way to Select Mobile Station

Based on an expected transfer rate estimated by each mobile station, each mobile station determines a user to be provided with communication services through base station cooperation, from among all users. In contrast to this, after each mobile station feeds back an expected transfer rate to a base station, the base station may select a mobile station to be provided with communication services through base station cooperation. The expected transfer rate is generally expressed by the following equation:

Rᵢ=f(Pᵢ, γ̅ᵢ) [Eqn. 9]

Equation (8) is an example of specifically implementing Equation (9). In Equation (9), Pᵢ and γ̅ᵢ denote power allocated by a base station and average channel gain between the base station and a mobile station, respectively, and f(a, b) denotes a function into which a and b are input. Also, “i” denotes mobile station i.

If the average channel capacity Rᵢ determined by Equation (8) or (9) is smaller than a predetermined threshold value β, the mobile station determines to perform communications through base station cooperation. Here, the threshold value β is a very important value for determining the number of mobile stations to perform communications through base station cooperation. When the threshold value β is too large, a large number of mobile stations determine to perform communications through base station cooperation, and gain obtained through base station cooperation decreases because mobile stations located at the cell center are selected. On the contrary, when the threshold value β is too small, the total amount of resources used for base station cooperation is reduced because only a few mobile stations located at cell edges are selected. Thus, resource allocation gain is also reduced. The base station adjusts the number of mobile stations, which can be provided with communication services through base station cooperation, by adjusting the threshold value β, and all mobile stations within a cell can be informed of the threshold value β over a separate broadcast channel. An example of determining the threshold value β according to a simulation result is shown below in Table 1.

TABLE 1

| | base station | | | | |
|---|---|---|---|---|---|
| | cooperation | | | | |
| | method not | | | | |
| | applicable | β = 0.7 | β = 1 | β = 1.5 | β = 2 |
| no. of mobile | 0 | 4 | 6 | 11 | 16 |
| stations to be | | | | | |
| provided with | | | | | |
| communication | | | | | |
| services | | | | | |
| through base | | | | | |
| station | | | | | |
| cooperation | | | | | |
| minimum | 0.5519 | 0.9046 | 1.1427 | 0.8011 | 0.6799 |
| capacity within | | (+63.91%) | (+107.09%) | (+45.15%) | (+23.19%) |
| cell | | | | | |
| overall | 147.1703 | 141.0945 | 139.8302 | 134.1907 | 126.1302 |
| capacity | | (−4.12%) | (−4.98%) | (−8.81%) | (−14.3%) |

A mobile station selects base stations in order of excellence in their signal strength, and transmits a request for communications through base station cooperation to the selected base stations. Here, the mobile station may transmit the request to a serving base station that is currently in communication with the mobile station, or may transmit the request directly to the base stations selected for base station cooperation. Also, the number of base stations to be selected for base station cooperation may vary according to the determination by the mobile station, or may be fixed to a predetermined value of the system.

Upon determining the base stations for base station cooperation, the mobile station feeds back the identifiers of the determined base stations and average channel gains between the base stations and the mobile station to the serving base station. Instead of the average channel gain, the mobiles station may also feed back any one of an average reception power to noise ration and an average reception power to noise and interference ratio to the serving base station.

### (3) Way to Allocate Resources to Mobile Station

Supposing that Mk is the number of sub-channels allocated to a kth mobile station to be provided with communication services through base station cooperation, the average channel capacity of the kth mobile station is R′ₖ=mₖRₖ. Here, Rₖ is a transfer rate that is expected after base station cooperation is applied, and can be obtained by Equation (11) as given below. Channel capacity is generally expressed by the following equation:

Rₖ=g(P_{k,1}, . . . , P_{KB}, γ̅ₖ₁, . . . , γ̅_{kB}) [Eqn.10]

In Equation (10), P_{kb} and γ̅_{kb} denote power which a bth base station allocates to the kth mobile station and average channel gain between the bth base station and the kth mobile station, respectively, and g(a) denotes a function into which respective elements of a vector a are input.

As an example of specifically implementing Equation (10), in the case where two base stations perform cooperative data transmission by using the Alamouti code, average channel capacity can be expressed by the following equation:

$${R}_{k} = \frac{1}{{P}_{k , 1} {\overline{γ}}_{k , 1} - {P}_{k , 2} {\overline{γ}}_{k , 2}} {log}_{2} e [ {P}_{k , 1} {\overline{γ}}_{k , 1} {e}^{\frac{{N}^{′}}{{P}_{k , 1} {\overline{γ}}_{k , 1}}} {E}_{1} ( \frac{{N}^{′}}{{P}_{k , 1} {\overline{γ}}_{k , 1}} ) - {P}_{k , 2} {\overline{γ}}_{k , 2} {e}^{\frac{{N}^{′}}{{P}_{k , 2} {\overline{γ}}_{k , 2}}} {E}_{1} ( \frac{{N}^{′}}{{P}_{k , 2} {\overline{γ}}_{k , 2}} ) ] \qquad [ Eqn . 11 ]$$

Let K and M be the number of mobile stations to be provided with communication services through base station cooperation and the total number of sub-channels allocated to the mobile stations, respectively. Also, let P_{coop,b} be the total power allocated to those mobile stations by a bth base station. A resource allocation formula as given in the following equation can be established using the average channel capacity Rₖ:

$${max}_{{n}_{k} , {p}_{1 , k} , {p}_{2 , k}} {min}_{k , k = 1 … K} {R}_{k}^{′} \{ \begin{matrix}{\sum }_{k = 1}^{K} {P}_{b , k} \leq {P}_{coop , b} \\ {\sum }_{k = 1}^{K} {m}_{k} \leq M\end{matrix} for b = 1 , 2 , … , B \qquad [ Eqn . 12 ]$$

In Equation (12), Bis the number of base stations providing base station cooperation. In order to accomplish ideal resource allocation, mₖ and P_{1,k},P_{2,k}, . . . , P_{B,k} must be allocated in such a manner as to satisfy R′₁=R′₂= . . . =R′ₖ. Here, P_{b,k} denotes power allocated to the kth mobile station by the bth base station.

FIG. 2 illustrates a procedure in which a base station allocates power and resources to mobile stations.

Referring to FIG. 2, in step 201, the base station initializes the value of a variable Z* to 0, and proceeds to step 203. In step 203, the base station allocates the same number of sub-channels and the same amount of power to all mobile stations to be provided with communication services through base station cooperation, and proceeds to step 205. In step 205, the base station calculates expected transfer rates of the respective mobile stations, and proceeds to step 207. In step 207, the base station derives a minimum value from the calculated expected transfer rates, and determines the minimum value as a Z value, and proceeds to step 209. In step 209, the base station reallocates power to the mobile stations such that R′₁=R′₂= . . . =R′ₖ=Z is satisfied, and proceeds to step 211. Here, Z denotes the minimum expected transfer rate among the expected transfer rates of the respective mobile stations, and can be expressed by Z=min(R′ₖ). That is, the base station reallocates power to the mobile stations by considering the minimum expected transfer rate.

When the base station allocates power by increasing the Z value in step 211, it determines if the amount of power to be allocated exceeds the total amount of power. If a result of the determination shows that the amount of power to be allocated exceeds the total amount of power, the base station proceeds to step 215. If the result shows that the amount of power to be allocated doesn't exceed the total amount of power, the base station returns to step 209 via step 213. In step 213, the base station increases the Z value.

The base station must find an optimum Z value within the limit of the total power under the current sub-channel allocation situations. Thus, in step 215, the base station compares an optimum Z value with the Z* value, and proceeds to step 217 when the Z value is larger than the Z* value. However, when the Z value is smaller than the Z* value, the base station allocates sub-channels and power, the number and amount of which are finally determined according to the mobile stations, and then ends the procedure. In step 217, the base station updates Z* by Z with a larger value, and proceeds t step 219. In step 219, the base station reallocates sub-channels according to the mobile stations. In allocating sub-channels in step 219, the base station allocates one of sub-channels, which are allocated to a mobile station requiring the smallest power, to a mobile station requiring the largest power.

FIG. 3 illustrates a procedure of providing a mobile station with communication services through base station cooperation.

Referring to FIG. 3, in step 301, the mobile station measures the strengths of signals received from a serving base station and neighboring base stations, and proceeds to step 303. In step 303, the mobile station determines average channel capacity, and proceeds to step 305.

In step 305, the mobile station determines if the average channel capacity is smaller than a predetermined threshold value. If a result of the determination shows that the average channel capacity is smaller than the predetermined threshold value, the mobile station proceeds to step 307, and otherwise, returns to step 301.

In step 307, the mobile station selects base stations that are to provide the mobile station with communication services in cooperation with each other, and proceeds to step 309. In step 309, the mobile station feeds back information on the selected base stations and their channel conditions to the serving base station or the base station from which the mobile station is provided with communication services, and proceeds to step 311. Here, an example of the information on channel conditions may include average channel gain.

In step 311, the mobile station is allocated power and resources from the base stations selected for base station cooperation, and proceeds to step 313. In step 313, the mobile station performs signal transmission/reception through cooperation between at least two base stations.

According to the present invention as described above, since a mobile station is provided with communication services from at least two base stations that cooperate with each other, there is an advantage in that the communication performance of the mobile station can be improved. Also, since the mobile station itself determines a mobile station to be provided with communication services through base station cooperation, and a base station adjusts the number of target mobile stations for base station cooperation only by adjusting a threshold value, there is another advantage in that the amount of information to be fed back to the base station is reduced.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method of providing a mobile station with communication services through base station cooperation in a communication system, the method comprising the steps of:
receiving signals from two or more base stations;
measuring a strength of each of the signals received from the base stations;
estimating an expected transfer rate of the mobile station;
if the estimated expected transfer rate is below a predetermined reference value, selecting at least two of the bases stations in order of the strength of the received signal;
feeding back information on the selected base stations and channel conditions thereof to a serving base station that is providing the mobile station with the communication services or to a base station that is to serve the mobile station;
allocating power and resources to the mobile station by the selected base stations; and
performing signal transmission/reception with the selected base stations by using the allocated power and resources.

2. The method as claimed in claim 1, wherein the expected transfer rate is determined as a function of transmission power and average channel gain.

3. The method as claimed in claim 1, wherein the predetermined reference value is determined in consideration of a number of mobile stations to be provided with the communication services through the base station cooperation, and is broadcasted to the mobile stations.

4. The method as claimed in claim 2, wherein the expected transfer rate is represented by a following equation,
$${R}_{i} = E [ log ( 1 + \frac{{P}_{i} {γ}_{i}}{{N}^{′}} ) ] = {e}^{\frac{{N}^{′}}{{P}_{i} {\overline{γ}}_{i}}} {log}_{2} {E}_{1} ( \frac{{N}^{′}}{{P}_{i} {\overline{γ}}_{i}} )$$
where, Pᵢ and γ̅ᵢ denote power allocated by a base station controlling a cell within which mobile station i is located and average channel gain between the base station and the mobile station i, respectively, N′ denotes Gaussian noise corresponding to a sum of noise and interference, and E₁ denotes an integral exponential function as expressed by
$${E}_{1} ( x ) = {\int }^{∞} \frac{{e}^{- xt}}{t} d t .$$

5. The method as claimed in claim 1, wherein the information on channel conditions comprises at least one of average channel gain, an average reception power to noise ratio, and an average reception power to noise and interference ratio.

6. A method of providing a mobile station with communication systems by a base station in a communication system, the method comprising the steps of:
allocating a same number of sub-channels and same power to each of target mobile stations for base station cooperation;
calculating an expected transfer rate of each of the mobile stations, and determining a minimum expected transfer rate;
reallocating power in such a manner as to satisfy the minimum expected transfer rate; and
if a sum of reallocated power exceeds a total sum of power, and the minimum expected transfer rate is below a predetermined expected transfer rate, reallocating a sub-channel of a mobile station with highest gain per unit sub-channel to a mobile station with lowest gain per unit sub-channel.

7. The method as claimed in claim 6, wherein the expected transfer rate is represented by a following equation,
$${R}_{i} = E [ log ( 1 + \frac{{P}_{i} {γ}_{i}}{{N}^{′}} ) ] = {e}^{\frac{{N}^{′}}{{P}_{i} {\overline{γ}}_{i}}} {log}_{2} {E}_{1} ( \frac{{N}^{′}}{{P}_{i} {\overline{γ}}_{i}} )$$
where, Pᵢ and γ̅ᵢ denote power allocated by a base station controlling a cell within which mobile station i is located and average channel gain between the base station and the mobile station i, respectively, N′ denotes Gaussian noise corresponding to a sum of noise and interference, and E₁ denotes an integral exponential function as expressed by
$${E}_{1} ( x ) = {\int }^{∞} \frac{{e}^{- xt}}{t} d t .$$

8. The method as claimed in claim 6, wherein the mobile stations comprise mobile stations to be provided with the communication services through the base station cooperation.

9. The method as claimed in claim 6, further comprising the steps of:
receiving feedback of channel condition information from each of the mobile stations; and
determining if the base station cooperation is performed for each of the mobile stations, by considering the fed back channel condition information.

10. A communication system comprising:
a mobile station for receiving signals from two or more base stations, measuring a strength of each of the signals received from the base stations; estimating an expected transfer rate thereof, selecting at least two of the bases stations in order of the strength of the received signal if the estimated expected transfer rate is below a predetermined reference value, feeding back information on the selected base stations and channel conditions thereof to a serving base station that is providing the mobile station with communication services or to a base station that is to serve the mobile station, being allocated power and resources by the selected base stations, and performing signal transmission and reception with the selected base stations by using the allocated power and resources; and
the two or more base stations.

11. The communication system as claimed in claim 10, wherein each of the base stations allocates a same number of sub-channels and same power to each of target mobile stations for base station cooperation, calculates the expected transfer rate of each of the mobile stations, determines a minimum expected transfer rate, reallocates power in such a manner as to satisfy the minimum expected transfer rate, and reallocates a sub-channel of a mobile station with highest gain per unit sub-channel to a mobile station with lowest gain per unit sub-channel if a sum of reallocated power exceeds a total sum of power, and the minimum expected transfer rate is below a predetermined expected transfer rate.

12. The communication system as claimed in claim 10, wherein the expected transfer rate is represented as a function of transmission power and average channel gain.

13. The communication system as claimed in claim 10, wherein the predetermined reference value is determined in consideration of a number of mobile stations to be provided with the communication services through the base station cooperation, and is broadcasted to the mobile stations.

14. The communication system as claimed in claim 11, wherein the expected transfer rate is represented by a following equation,
$${R}_{i} = E [ log ( 1 + \frac{{P}_{i} {γ}_{i}}{{N}^{′}} ) ] = {e}^{\frac{{N}^{′}}{{P}_{i} {\overline{γ}}_{i}}} {log}_{2} {E}_{1} ( \frac{{N}^{′}}{{P}_{i} {\overline{γ}}_{i}} )$$
where, Pᵢ and γ̅ᵢ denote power allocated by a base station controlling a cell within which mobile station i is located and average channel gain between the base station and the mobile station i, respectively, N′ denotes Gaussian noise corresponding to a sum of noise and interference, and E₁ denotes an integral exponential function as expressed by
$${E}_{1} ( x ) = {\int }^{∞} \frac{{e}^{- xt}}{t} d t .$$

15. The communication system as claimed in claim 10, wherein the mobile station feeds back at least one of average channel gain, an average reception power to noise ratio, and an average reception power to noise and interference ratio to the base stations.
